(19) United States
(12) Patent Application Publication
(10) Pub. No.: US 2003/0167639 A1
(43) Pub. Date: Sep. 11, 2003

(54) Safety razor

(76) Inventor: Heike Sassenberg, Berlin (DE)

Correspondence Address: Law Offices of Karl Hormann, 86 Sparks Street, Cambridge, MA, 02138-2216, US

(21) Appl. No.: 10/161,525

(22) Filed: Jun. 3, 2002

(30) Foreign Application Priority Data
Mar. 8, 2002 (DE) 200 03 800.9

(51) Int. Cl. B26B 19/06

(52) U.S. Cl. 30/50

(57) ABSTRACT

A safety razor provided with an elongate handle and first and second blade supports at opposite ends of the handle, one of the blade supports being substantially smaller than the other blade support to allows shaving patterns of small contours into a beard.

### BACKGROUND OF THE INVENTION

1. Field of the Invention

The invention, in general, relates to a safety razor of the kind provided with razor blades and, more particularly to a safety razor suitable for producing shaved patterns or contours.

2. The State of the Prior Art

Many different safety razors are known with an approximately rectangular, oval or circular external configuration of the blade head. In most cases, these known safety razors are provided with one of more blades disposed in parallel with respect to each other in a rigid or hinge-mounted blade head with an appropriate skin engagement surface. Blade structures of annular cutting edge formations disposed in various usually round or oval blade mounting heads are as well.

For instance, U.S. Pat. Nos. 2,614,321; 3,465,436 and 3,702,026 as well as European Patent EP 0,759,836 describe razors with round or oval blade mounting heads. WO 02/07935 A1 discloses a wet razor the blade mounting head of which is provided with a skin engaging surface of approximately rectangular configuration with strongly rounded corners. A special shaving head for razors is described in German patent specification DE 44 05 576 C2. Its skin engaging surface, seen in the shaving direction, is concavely bulged such that during shaving the skin in the area of the concave skin engagement surface is convexly curved.

The disadvantage of all known safety or wet razor devices is that the dimensions of their skin engaging surfaces, relative to desired beard contours, are rather too large. Moreover, they suffer from the drawback that as a rule their direct cutting surfaces are of rectangular configuration with a wide margin between blades and outer contour of the blade head. Another significant disadvantage of those razors is that special contours in a beard necessitate the use of another razor.

### OBJECTS OF THE INVENTION

An object of the invention is to eliminate the difficulty encountered by a bearded person seeking to shave defined, more particularly small contours into or out of the surface of his beard in consequence of the unavailability of suitable safety razors. With conventional safety razors, such contours can only be cut at the risk of cuts, particularly in the area of the lower lip.

### BRIEF SUMMARY OF THE INVENTION

In accordance with the invention, a safety razor is being proposed combining a conventional safety razor at one end of its handle with a small or miniaturized razor of a diameter in the order of the handle disposed at its opposite end. The miniaturized razor disposed at the opposite end of the handle is provided with a small blade unit with a skin engaging surface which is smaller than the skin engaging surface of the conventional blade head at the other end of the handle. The geometric configuration of the small blade unit of the safety razor in accordance with the invention is different from the blade head at the other end of the handle of safety razor. The blade units are configured to conform to individually desired beard contours and are provided with a round, oval or polygonal skin engaging surface. One or more blades may be arranged in the blade unit. They may be provided with wedge-shaped cutting edges at one side or both sides. The blades are supported in a frame in a conventional manner and, depending upon their shape and size of the blade unit, they are centered on a point of support.

In a particular embodiment the skin engaging surface and the blades of the blade unit are convexly bulging in the direction of a surface to be shaved. The blade unit may be fixedly or removably mounted on the handle. Alternatively, the blade unit may be mounted on the handle by a hinge. In order to conform to individual desires in respect of a beard contour and to shave even very small contours, the blade unit-is of a diameter substantially corresponding to the diameter of the handle. In accordance with a further embodiment, the blade unit is covered by a protective hood snap-fitted to the handle by a grooved edge.

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

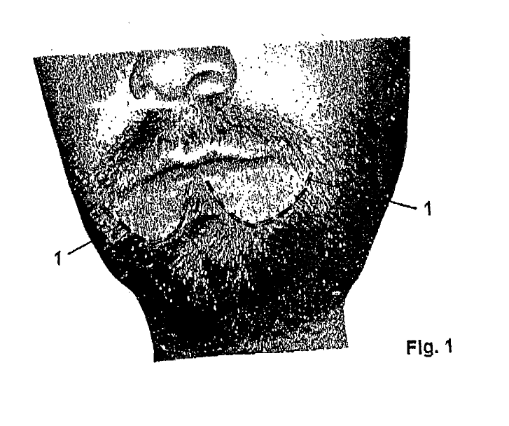

FIG. 1 depicts a beard with contoured lines;

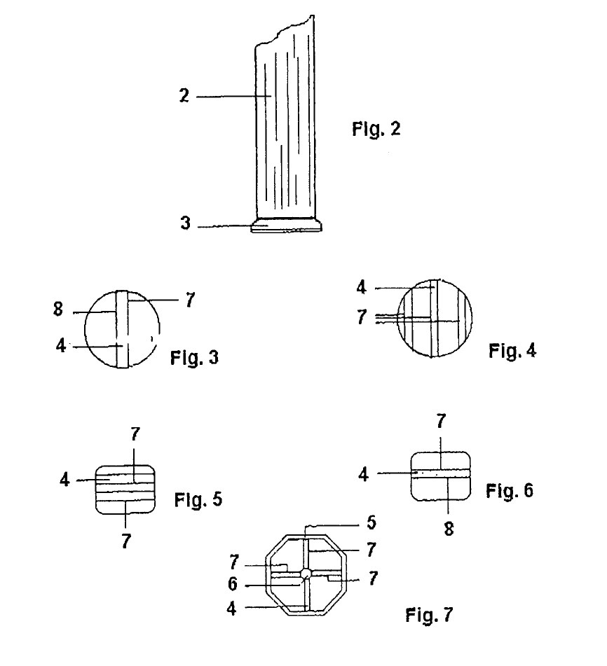

FIG. 2 is a sectional view of the lower portion of a handle of a safety razor;

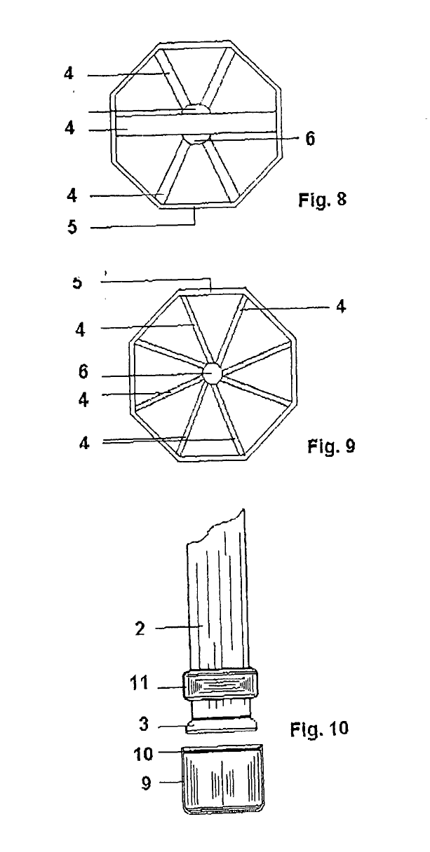

FIGS. 3-9 are schematic representations of blade units for contour shavings;

FIG. 10 is an exploded view of the lower portion of the handle of a safety razor and a protective cover; and

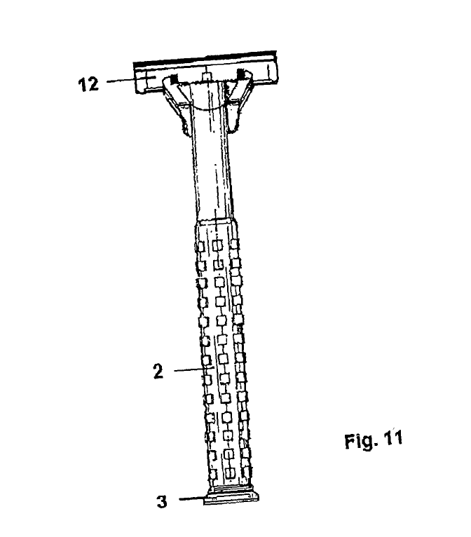

FIG. 11 depicts a conventional safety razor with a small blade unit in accordance with the invention.

### DETAILED DESCRIPTION OF THE PREFERRED EMBODIMENT

FIG. 1 depicts the lower facial section of a man who likes to have his beard shaved in fancy individually determined contours. The desired ideal contour is indicated by a contour line 1. With conventional safety razors, such contours may either be shaved only with great difficulty or, more likely, not at all, and in the event not without great risk of cuts, particularly in the area of the lower lip.

In order to avoid the necessity of several different safety razors, the invention proposes to arrange an additional blade unit 3 at the other end of a handle 2 of a conventional safety razor. The blade unit 3 is dimensionally structured such that it either substantially corresponds to the diameter of the handle 2 or, depending on special configurations of the handle 2, has a diameter which is approximately identical to that of the handle 2. This blade unit thus ensures that even the smallest contours, more particularly rounded configurations, may be shaved out of a beard. For cleaning the blade unit 3, shavings and residual lather are simply rinsed off by a water jet from a faucet. In accordance with a particular embodiment of the invention, the blade unit 3 may be unscrewed from the handle 2 for cleaning.

In the case of throw-away razors 2 which are discarded once the blades have become dull, the blade unit 3 will be fixedly connected to the handle 2. Safety razors with a replaceable conventional blade head 12 will be provided, at the opposite end of their handle 2, with a releasable and replaceable blade unit 3.

FIGS. 3-9 schematically depict, in top elevation, several different geometric structures of blade units 3 with one or more blades 4. Depending upon the geometric external contour of the handle 2, the blade units 3 may be selected to be of circular, elliptical or polygonal configuration. The blades 4 are mounted in a frame 5 which is preferably made of a polymeric material. The blades 4 may either be glued to the frame 5, or they may be injection-molded into it. In a particular embodiment, the blades 4 are fixed to a centrally disposed mounting and support point 6. Such mountings by means of a mounting and support point 6 are of particular use in the case of somewhat larger blade units 3.

As is well known, the blades 4 of the blade unit 3 are provided, for preferably circular shaving motions, with wedge-shaped cutting edges 7 and are structured as single (FIGS. 3 and- 6) or multiple blade (FIGS. 4, 5, 7-9) arrangements. In accordance with the invention, both margins of the blades 4 may be provided with wedge-shaped cutting edges 7, 8 to yield particularly advantageous shaving effect. So-called tandem blades as shown in FIGS. 4 and 5 may be applied. The blades 4 may be straight or curved and arranged as singles, parallel, crossed, in a star-like configuration and/or in different planes.

FIG. 10 depicts a special embodiment of the end of a handle 2 with a blade unit 3 in accordance with the invention and a schematically shown protective cover 9 adapted to be seated on the handle by snap-fitting into grooves or a grooved margin 10 above a bulge 11 in the handle.

FIG. 11 shows a conventional safety razor with a blade head 12 at the upper end of its handle 2 structured as an inventive combination device provided with a blade unit 3 at the lower end of the handle 2. Following large surface shaving with the blades in blade head 2, the user may use the blade unit 3 to shave individualized contours in his beard (FIG. 1) by rotary shaving motion of the blade unit 3.

What is claimed is:

1. A safety razor, comprising:
an elongated handle of predetermined diameter;
a first blade support provided with a first skin engaging surface dimensioned to exceed the diameter of the handle and disposed at one end thereof; and
a second blade support provided with a second skin engaging surface smaller than the first skin engaging surface and disposed at the other end of the handle.

2. The safety razor of claim 1, wherein the first blade support is releasably mounted on the handle.

3. The safety razor of claim 1, wherein the first blade support is affixed to the handle.

4. The safety razor of claim 1, wherein the first blade support is adapted to support at least one blade.

5. The safety razor of claim 1, wherein the geometric structure of the second blade support is different from the geometric structure of the first blade support.

6. The safety razor of claim 5, wherein the skin engaging surface of the second blade support is substantially circular.

7. The safety razor of claim 5, wherein the skin engaging surface of the second blade support is substantially oval.

8. The safety razor of claim 5, wherein the skin engaging surface of the second blade support is substantially polygonal.

9. The safety razor of claim 1, wherein each of the first and second blade supports is provided with at least one blade.

10. The safety razor of claim 9, wherein the blade is provided with at least one cutting edge of wedge-shaped configuration.

11. The safety razor of claim 9, wherein the skin engaging surface of the second blade support and the blade are convexly bulging in the direction of a shaving surface.

12. The safety razor of claim 9, wherein the blade is centrally fixed to a support point.

13. The safety razor of claim 1, wherein the second blade support is fixed to the handle.

14. The safety razor of claim 1, wherein the second blade support is releasably mounted on the handle.

15. The safety razor of claim 14, wherein the second blade support is threadedly connected to the handle.

16. The safety razor of claim 1, wherein the second blade support is hingedly connected to the handle.

17. The safety razor of claim 1, wherein the diameter of the second blade support substantially corresponds to the diameter of the handle.

18. The safety razor of claim 1, wherein the second blade support is provided with a protective cover.

19. The safety razor of claim 18, wherein the protective cover is retained on the handle by a snap-fit connection.
